(19) United States
(12) Patent Application Publication
(10) Pub. No.: US 2013/0167883 A1
(43) Pub. Date: Jul. 4, 2013

(54) METHOD AND DEVICE TO ENABLE SEMICONDUCTOR PROCESSING IN SOLUTION THAT GENERATES PARTICLES

(71) Applicants: JOHN A. FITZSIMMONS, HOPEWELL JUNCTION, NY (US); CHARLES JESSE TAFT, HOPEWELL JUNCTION, NY (US); JENNIFER V. MUNCY, HOPEWELLL JUNCTION, NY (US)

(72) Inventors: JOHN A. FITZSIMMONS, HOPEWELL JUNCTION, NY (US); CHARLES JESSE TAFT, HOPEWELL JUNCTION, NY (US); JENNIFER V. MUNCY, HOPEWELLL JUNCTION, NY (US)

(73) Assignee: INTERNATIONAL BUSINESS MACHINES CORPORATION, Armonk, NY (US)

(21) Appl. No.: 13/342,478

(22) Filed: Jan. 3, 2012

(51) Int. Cl. B08B 3/00; B01D 21/26

(52) U.S. Cl. 134/109; 210/787; 210/512.1

(57) ABSTRACT

The present disclosure relates to semiconductor device manufacturing and, more particularly, to removing a mask material, especially an ion implanted and patterned photo resist, using an aqueous cerium-containing solution. The present invention relates to a method and apparatus for cleaning the chemical materials utilized for cleaning semiconductor wafers. The invention utilizes a centrifugal filter to eliminate heavy materials from the cleaning solution.

### FIELD OF THE INVENTION

The present disclosure relates to semiconductor device manufacturing and, more particularly, to removing a mask material, especially an ion implanted and patterned photo resist, using an aqueous cerium-containing solution. The present invention relates to a method and apparatus for cleaning the chemical materials utilized for cleaning semiconductor wafers.

### BACKGROUND

Since the inception of the integrated circuit, semiconductor processing yield has been sensitive to particle contamination induced loss. As the dimensions of the semiconductor device have shrunk, the challenge of yield loss due to contamination has become increasing difficult especially as the device dimensions approach or even decrease below the size of the average contamination field within a given process system. As a result, often there are multiple cleaning steps added just to reduce particle contamination induced yield loss within any given process device manufacturing scheme.

Concomitant with the difficulty of particle contamination within a process or process solution is the added difficulty that once particles attach and dry on a semiconductor surface, it is often very difficult if not impracticable to remove these particles without inducing damage to sensitive semiconductor surfaces. Thus, the standard approach within semiconductor technology is to purify solutions used in semiconductor processing to remove particles before any semiconductor device hardware is exposed to a process solution. The typical approach uses filtration at an absolute value determined by the flow dynamics of the process system. For example: the desired absolute filtration pore size of a filter is determined by the total system volume and the required chemical exchange rate during a chemical process exposure; whereby, two key dependant variables are the desired flow rate of a pumped chemical solution and the pressure drop over a filter of a given exclusion size. This typical approach has been somewhat successful as long as the principle origination of particle challenge is finite and limited in magnitude. An example of this method in practice is the filtration of an incoming chemical supply to remove inert particle contamination resulting from random atmospheric exposure.

Recognizing the difficult challenge that particle contamination presents to semiconductor processing, it is an objective of semiconductor process design to prevent or, if it is impractical to prevent then, minimize the production of particles during a semiconductor manufacturing process. For example, a typical wet chemical process operation is the removal of undesired materials, such as silicon dioxide, silicon nitride, or photo-resist masking materials. In the case of silicon dioxide or silicon nitride, an etchant is used that reacts with and dissolves these materials into a true solution which can be filtered without excessive pressure drop; and thereby, enable reuse of these chemistries for continued processing as well as minimizing the waste and cost that can result from a single use methodology. A specific example is the use of hydrofluoric acid solutions to etch silicon dioxide; wherein, hexafluorosilicic acid is produced, resulting in a true solution that may be subjected to filtration and reuse. In the case of the removal photo-resist masking materials (also called photo-resist striping), the high molecular weight nature of the photo-resist polymer base prevents an extreme difficulty to true solution formation by chemical reaction within a very short contact time. As such, many photo-resist stripping process either are designed to be single use to waste disposal, or employ a reservoir system; whereby, additional digestion occurs within the reservoir system such that a true solution is produced and the photo-resist chemistry may be filtered and reused. This digestion within a reservoir system takes place after photo-resist removal occurs from the wafer surface and thereby is an intentional process design to again, enable reuse of these chemistries for continued processing with the objectives of minimizing the waste and cost that can result from a single use methodology. A specific example is the use strong oxidizing agents such as peroxymonosulfuric acid or peroxydisulfuric acid in a solution with sulfuric acid as photo-resist stripping and digestion agents. These strong oxidizing agents react with the photo-resist polymer materials to produce water and carbon dioxide; and as such, the result is a true solution that may be subjected to filtration and reuse.

As process challenges increase and become more difficult with the decreasing fundamental dimensions of semiconductor circuitry, it becomes increasingly difficult to extend the use of traditional solutions and processes to produce semiconductor hardware. As a result new processes and chemistries have evolved to enable the production of these semiconductor devices at these increasingly difficult to manufacture dimensions. As with any new process, the conditions and operations that previously had been effective may no longer be sufficient to produce successful results.

We have determined that during some processing conditions particles have been discovered that may be coincident with the required chemical process and the process can not be modified to eliminate the formation of said particles. One example of such a solution may be found in U.S. patent application Ser. No. 13/295,677, “AQUEOUS CERIUM-CONTAINING SOLUTION HAVING AN EXTENDED BATH LIFETIME FOR REMOVING MASK MATERIAL” filed Nov. 14, 2011, currently pending and hereby incorporated by reference. U.S. patent application Ser. No. 13/295,677 teaches an aqueous solution of a cerium (IV) containing complex or salt (i.e., an aqueous cerium-containing solution) having an extended bath lifetime is provided. In one embodiment, the extended lifetime is achieved by adding at least one booster additive to an aqueous solution of the cerium (IV) complex or salt. In another embodiment, the extended lifetime is achieved by providing an aqueous solution of a cerium (IV) complex or salt and a cerium (III) complex or salt. The cerium (III) complex or salt can be added or it can be generated in-situ by introducing a reducing agent into the aqueous solution of the cerium (IV) complex or salt. The aqueous solution can be used to remove a mask material; especially an ion implanted and patterned photo resist, from a surface of a semiconductor substrate.

By “extended bath lifetime” it is meant that the aqueous cerium-containing solution of the prior application which contains either the at least one booster additive or the cerium (III) complex or salt is stable and does not show any significant decrease in performance over a longer period of time as compared to an equivalent aqueous cerium-containing solution that does not include either that at least one booster additive or a cerium (III) complex or salt. Within this newly developed process system, the chemical reaction results not only in the desired removal of unwanted photo-resist material, but also in a concomitant formation of an insoluble material that originates as a product of the chemical process solution. Thus, these two processes may not be separated nor can the undesired process of particle formation prevented. While patent application Ser. No. 13/295,677 details a methodology to delay the unset of the particle formation, it is not a method to neither prevent nor mitigate the result of particle formation.

Thus, there is a need to maintain capability to utilize the desired process conditions without the negative impact of these coincident particles. Normal methods of particle reduction in semiconductor technology were applied to this problem and were demonstrated to be ineffective as a solution to this intrinsic particle problem. For example: a filtration methodology was applied as a potential solution and these filters clogged so rapidly with precipitate material that they were an ineffective solution to this problem. In addition, the filters which trapped the particles also may have resulted in both concentrating the particles and maximizing the available catalytic reactive surface of said particles to the process solution resulting in a chemical reaction that avalanched into a significant creation of particulates.

As another example: a post clean known to reduce the yield impact from particle deposition was employed and this clean was unable to significantly reduce the number of adherent particles. Thus, there is a need for tooling improvements that can address this issue of auto particle generation or co-generation in order to enable the employment of solutions that are required for semiconductor manufacturing, yet have these particle issues.

Our invention utilizes the mass differences of the insoluble particles generated, during the use of our process chemistry to remove photo-resist, with respect to the initial (and remaining unmodified) states of our process chemistry which are true solutions: to enable the separation of the desired solution (remaining unmodified initial solution) for continued semiconductor processing with significantly reduced particle levels but with the coincident maintenance of the desired processing solution properties.

Semiconductor processing yield is very sensitive to particle contamination induced loss. Often there are multiple cleaning steps added just to reduce particle contamination induced yield loss. Once particles attach and dry to on a semiconductor surface, it is often very difficult to remove these particles without inducing damage to sensitive semiconductor surfaces. During some processing conditions particles have been discovered that may be coincident with the required chemical process and the process can not be modified to eliminate the formation of said particles. Thus, there is a need to maintain capability to utilize the desired process conditions without the negative impact of these coincident particles. Normal methods of particle reduction in semiconductor technology were applied to this problem and were demonstrated to be ineffective as a solution to this intrinsic particle problem. For example: a filtration methodology was applied as a potential solution and these filters clogged so rapidly with particulate material that they were an ineffective solution to this problem. As another example: a post clean known to reduce the yield impact from particle deposition was employed and this clean was unable to significantly reduce the number of adherent particles. Thus, there is a need for tooling improvements that can address this issue of auto particle generation or co-generation in order to enable the employment of solutions that are required for semiconductor manufacturing, yet have these particle issues.

The inventors have therefore determined that not only is it necessary to provide for chemistry that allows for a lengthened useful life of the chemistry utilized but in addition there remains a need for a process and/or a device that removes particulates in a manner that allows for the solution to be utilized continuously without the issues identified in the application of filtration. When a method to remove these undesired particles is such employed, then the additional objectives derived from a process that enables reuse of chemistries for continued processing (rather than the much undesired single use methodology): the concomitant benefits of both cost and waste minimization are also achieved.

### SUMMARY

The inventors have determined that a benefit may be achieved by utilizing the mass differences of the insoluble particles generated during the use of our process chemistry to remove photo-resist with respect to the initial (and remaining unmodified) states of our process chemistry which are true solutions, to enable the separation of the desired solution (remaining unmodified initial solution) for continued semiconductor processing with significantly reduced particle levels but with the coincident maintenance of the desired processing solution properties. Semiconductor processing yield is very sensitive to particle contamination induced loss. Often there are multiple cleaning steps added just to reduce particle contamination induced yield loss. Once particles attach and dry on a semiconductor surface, it is often very difficult to remove these particles without inducing damage to sensitive semiconductor surfaces.

The inventors have determined that by utilizing a separation chamber the system is able to extend the bath life by enabling continuous flow processing and eliminating the need to operate discretely. In contrast to other particle removal systems which employ velocity to magnify mass differences in order to promote particulate separation from a system, our separation chamber utilizes directed quiescent flow to promote the removal of the undesired particle matter from the chemical process solution. By promoting laminar rather than turbulent flow, our separation chamber promotes segregation of the particle matter by gravitational force and directs this settled material to a containment area for removal from the process solution. The system maximizes quiescent flow through multiple design features, for example the inlet to the separation chamber is feed from a gravity driven reservoir and the outlet from the system is controlled such that pump induced force on the exiting fluid does not introduce turbulence into the separation chamber.

Another aspect of our invention is the use of a compound angles to both direct the separated material to the collection chamber initial downward angle (directional helical plane) and well as maintain maximum separation of the removed material by isolation of the collected particulate material within the directional helical plane by a second angle that promotes collection against the internal surface of external wall of the separation chamber. Thus the particle matter is sequestered and re-suspension of the particles once separated from the working fluid is avoided through minimization of interaction with the main body of the liquid within the separation chamber.

Still another aspect of our invention is the use of a culmination device to isolate the outlet from the central chamber and as such minimize the potential for re-suspension of particulate material into the output of the separation device.

The separation chamber comprises an inlet pipe into a cylinder with an inverted cone on the bottom to capture the precipitate. The side walls of the cylinder have a helical shaped lip that is at approximately 45 degree angle to catch the precipitate and allow it to flow to the bottom of the separation chamber. As the bath enters the chamber it flows in either a clockwise or counter clockwise direction. The helical shape may be arranged in the same direction as the flow of the bath or in the opposite direction based upon the type and size of the precipitate. The top of the chamber includes a culminator to ensure laminar flow of the bath.

### BRIEF DESCRIPTION OF THE SEVERAL VIEWS OF THE DRAWINGS

FIG. 1 shows one embodiment of an apparatus for removing particulate from the cleaning solution.

FIG. 2 illustrates one embodiment of the separation chamber.

FIG. 3 illustrates a top view of one embodiment of the culminator.

FIG. 4 illustrates a top view of a second embodiment of the culminator.

FIG. 5 illustrates a partial view of the side of one embodiment of the collection system.

### DETAILED DESCRIPTION

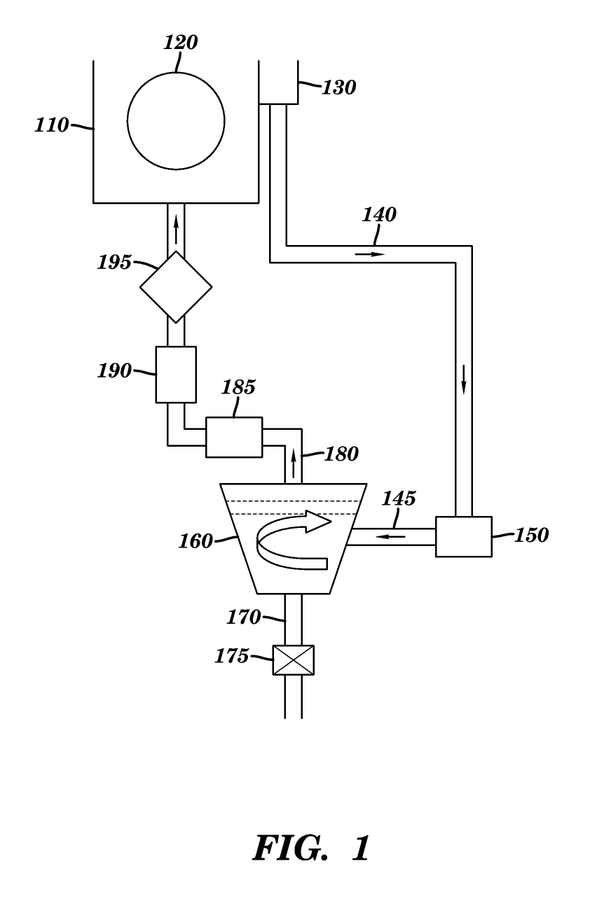

FIG. 1 shows one embodiment of an apparatus for removing particulates from the cleaning solution. The system comprises a process tank 110 in which the wafer 120 is cleaned. Wafer 120 may be a single wafer or a batch of wafers. The cleaning solution may be for example the solution taught in U.S. application Ser. No. 13/295,677. For example the aqueous solution may comprises at least one cerium (IV) complex or salt, the at least one cerium (IV) complex or salt can be, for example, cerium ammonium nitrate. The chemical formula of cerium ammonium nitrate may be expressed as Ce(NH₄)₂(NO₃)₆ or (NH₄)₂Ce(NO₃)₆. Cerium ammonium nitrate is also known as CAN, cerium (IV) ammonium nitrate, ceric ammonium nitrate and ammonium cerium nitrate. CAN is an orange, water-soluble salt that may be used as an oxidizing agent.

The solution may flow from process tank 110 to overflow weir 130. Piping 140 transfers the fluid to an optional reservoir chamber 150 to maintain the smooth flow from weir 130. Piping 145 transfers the fluid to the separation chamber 160. The separation chamber 160 produces two outputs the first clean fluid is transferred through piping 180. The second is the particulate or waste which is transferred through piping 170. Piping 170 is opened and closed utilizing valve 175.

The clean fluid may pass through a pump 185 and a heater 190. Prior to re-entering the process chamber 110, the clean fluid may pass through a polishing filter 195 to remove any residual precipitate. Due to the removal of the majority of the precipitate by the separation chamber 160, the filter 195 does not require changing as frequently as in the prior are applications. In addition as less precipitate is captured by filter 195 the catalyst affect described earlier is not as likely to occur.

As understood in the art separation chambers may be cascaded to increase the efficiency of particle removal as well as to increase isolation of the pump induced forces upon the initial stages of cascaded separation chambers. In one embodiment, pump 185 is designed with internal sump chambers or other methods to isolate upstream transfer of pump induced force that may accompany the pump use to maintain circulatory movement of the process solution. While the embodiment shown includes the sump chamber in pump 185, it is understood that the sump chamber may be separate from pump 185.

The precipitate captured by the separation chamber 160 drains through piping 170 and may be recycled. As stated above the particles in the precipitate comprises Cerium in one embodiment. Cerium is a rare earth metal and therefore quite valuable. When a filter is utilized the filter must be burned to release the Cerium for recycling. One benefit of this process is that the Cerium may be captured without the need to eliminate the filter first.

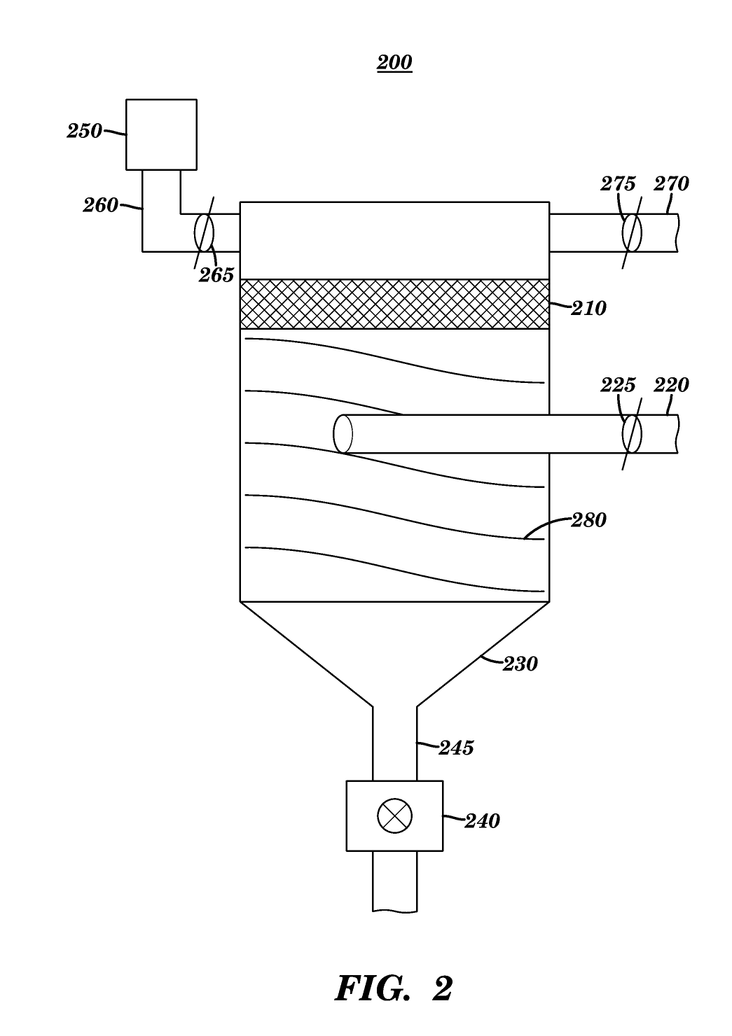

FIG. 2 illustrates one embodiment of the separation chamber. Chamber 200 receives the precipitate from pipe 220. The precipitate enters the chamber and is forced to flow in a clockwise manner. As the precipitate flows the heavier particles are naturally forced to the outer side of the chamber 200. The outer wall of chamber 200 has a helical shelf 280 which catches the particles and allows them to flow down to the inverted cone 230 on the bottom of chamber 200. When the particles gather in cone 230 they are able to flow out of the chamber through pipe 245. The bath or cleaning solution now primarily free of the particles flows upward through a culminator 210, to ensure laminar flow and out pipe 270 to return to the process tank 110 of FIG. 1. An air input 260 provides air to chamber 200 from air filter 250 when valve 265 is open.

Inlet 220 is controlled by valve 225 which determines when precipitate is able to flow. Valve 275 determines if the cleaning solution may flow through outlet 270. When valve 240 is open the particles are able to flow out of chamber 200 through pipe 245. During normal operation valves 225 and 275 are open and valves 245 and 265 are closed. To clear the particles from the chamber 200, valves 220 and 275 are closed and valve 240 is open. Once valve 240 is open valve 265 is opened and air is permitted to flow into chamber 200 further allowing the particles to flow out through pipe 245. In one embodiment, the opening of valve 265 does not occur until the fluid level has fallen below the bottom surface of the culminator 200.

The manufacture of the chamber 200 further may not be made from normal construction materials due to the corrosive characteristics of the bath. Therefore the chamber should be formulated from Teflon or other material that will resist the corrosive attributes of the bath.

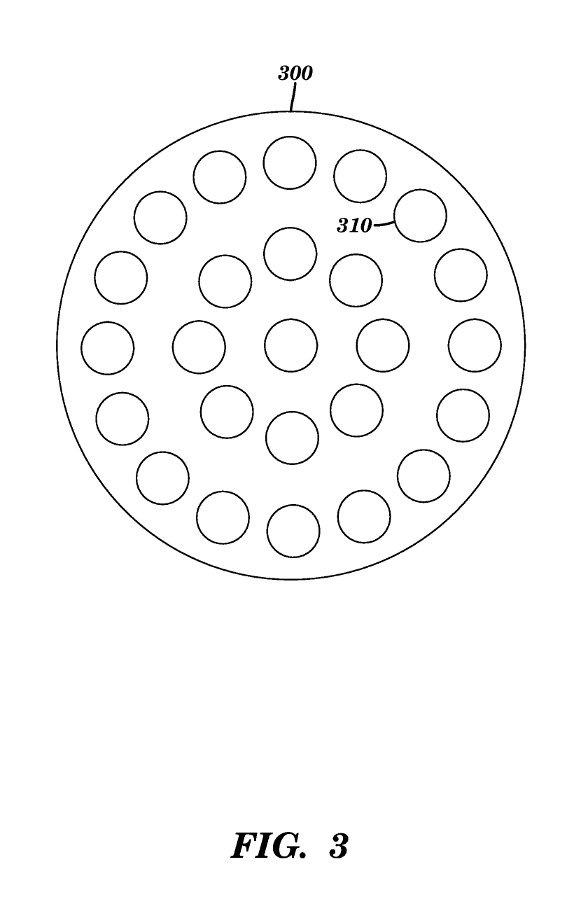

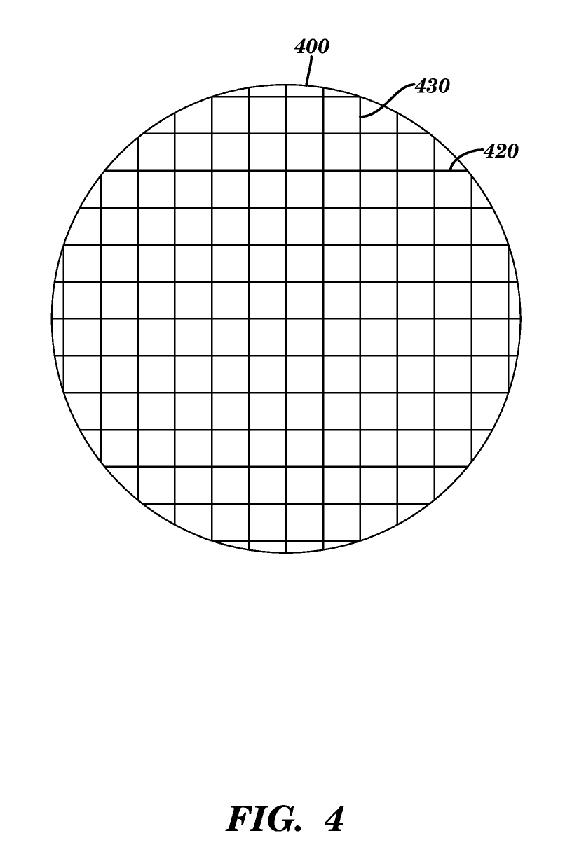

FIG. 3 illustrates a top view of one embodiment of the culminator. To ensure laminar flow the culminator 300 comprises a plurality of tubes 310 to allow flow. FIG. 4 illustrates a top view of a second embodiment of the culminator. In FIG. 4 culminator 400 comprises a series of plates 430 and 420 to form a series of square passages allow for laminar flow. While these embodiments illustrate squares and circles, hexagonal, or similar openings may be utilized to ensure laminar flow is obtained.

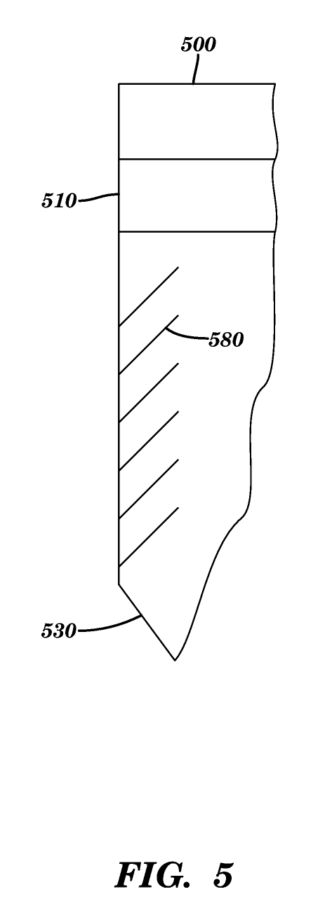

FIG. 5 illustrates a partial view of the side of one embodiment of the collection system. Chamber 500 as illustrated comprises the cone 530 and the culminator 510 as shown in FIG. 2. Helical shelf 580 is illustrated and illustrates that the shelf is at approximately a 45 degree angle such that once the particles reach the shelf they are captured and flow down to cone 530.

While the chamber is described for use with the removal of particles from a bath used in semiconductor production. It should be clear that the chamber may be utilized to remove particles from other fluids. For example the structure may be utilized for removal of particles from an air borne or gaseous fluid.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a process tank for cleaning semiconductor wafers with a solution;
a separation chamber for separating particulate from the solution, the separation chamber comprising a helical shelf for catching the particulate; and
a pump for transferring the solution from the separation chamber to the process tank.

2. The apparatus of claim 1, wherein the separation chamber further comprises a culminator to ensure laminar flow of the solution.

3. The apparatus of claim 2 further comprising an inverted cone to receive the particulate from the helical shelf.

4. The apparatus of claim 1 further comprising a weir adjacent to the process tank for setting the solution level in the process tank.

5. The apparatus of claim 1 further comprising a filter between the pump and the process tank.

6. The apparatus of claim 1 wherein the pump further comprises a sump chamber.

7. The apparatus of claim 3 further comprising:
a weir adjacent to the process tank;
a reservoir prior to the separation chamber;
a filter located between the pump and the process tank;
a heater; and
wherein the pump further comprises a sump chamber.

8. The apparatus of claim 1 wherein the solution comprises an aqueous solution of a cerium.

9. A separation chamber comprising:
an inlet pipe to provide a solution containing particulates from a system to the separation chamber;
a helical shelf on the outer wall of the separation chamber to catch the particulates from the solution;
an inverted cone on the bottom of the separation chamber to receive the particulates from the helical shelf; and
an outlet pipe to return the solution to the system.

10. The separation chamber of claim 9 further comprising a culminator located above the helical shelf to ensure laminar flow of the solution.

11. The separation chamber of claim 10 further comprising a waste pipe located at the bottom of the inverted cone.

12. The separation chamber of claim 11 further comprising an air input, wherein the outlet pipe and the inlet pipe are closed and the waste pipe and the air input are opened to permit the particulate to be released from the separation chamber.

13. The separation chamber of claim 9 where in the separation chamber is made of Teflon.

14. The separation chamber of claim 9 where in the solution comprises an aqueous solution of a cerium.

15. A method for filtering solution from of particulates comprising:
providing the solution containing a particulate to a separation chamber in a quiescent flow;
capturing the particulate on a helical shelf located on the outer wall of the chamber; and
returning the solution in a laminar flow.

16. The method claim 14 further comprising passing the solution through a culminator.

17. The method of claim 15 further comprising pumping the solution from the separation chamber wherein the pump comprises a sump chamber.

18. The method of claim 14, wherein the solution comprises an aqueous solution of a cerium.

19. A system for cleaning an aqueous solution of a cerium of particulates comprising:
a process tank for processing wafers in a semiconductor manufacturing line;
a weir for maintaining a solution level in the process tank;
piping to route the solution from the weir to a separation chamber to separate the particulates from the solution;
a pump to pump the solution from the separation chamber to the process tank.

20. The system of claim 18 wherein the separation chamber comprises a helical shelf for capturing particles containing cerium.

21. The system of claim 19 wherein the separation chamber comprises an inverted cone to receive the cerium particles from the helical shelf.
